(19) United States
(12) Patent Application Publication
(10) Pub. No.: US 2006/0007574 A1
(43) Pub. Date: Jan. 12, 2006

(54) Perpendicular recording patterned disk medium and magnetic disk drive loaded with patterned disk medium

(75) Inventors: Shuuichi Kojima, Ome-shi (JP); Makoto Asakura, Tokyo (JP); Kotaro Yamamoto, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/180,646

(22) Filed: Jul. 14, 2005

(30) Foreign Application Priority Data
Jul. 23, 2004 (JP) 2004-216345

(51) Int. Cl. G11B 5/09

(52) U.S. Cl. 360/48

(57) ABSTRACT

A patterned disk medium having a first surface and a second surface opposed to the first surface, includes a data pattern area formed in advance on each of the first surface and the second surface, a servo pattern area formed in advance like an arc in a radial direction, which divides the data pattern area in a plurality of pattern areas in a circumferential direction, and positioning marks formed used for positioning when the servo pattern area and the data pattern area are formed in advance.

### CROSS-REFERENCE TO RELATED APPLICATIONS

This application is based upon and claims the benefit of priority from prior Japanese Patent Application No. 2004-216345, filed Jul. 23, 2004, the entire contents of which are incorporated herein by reference.

### BACKGROUND OF THE INVENTION

1. Field of the Invention

The present invention relates to a perpendicular recording patterned disk medium in which a servo pattern section is physically formed on either side of a disk-shaped substrate in accordance with the presence and absence of a magnetic substance, and a magnetic disk drive loaded with the patterned disk medium.

2. Description of the Related Art

In general, servo information is recorded on a disk-shaped magnetic recording medium (disk medium) loaded into a magnetic disk drive in advance or when the medium is initialized. The servo information includes positional information necessary for locating a magnetic head in a target position on the medium. An area on which the servo information is recorded is called a servo area.

Jpn. Pat. Appln. KOKAI Publication No. 2004-079098 proposes a technique of a so-called patterned disk medium, such as a magnetic disk medium on which a servo area (servo zone) is formed in advance as an uneven servo pattern having a magnetic layer.

The Publication describes a recording medium having a patterned recording layer and a method of manufacturing the same, an imprint master having a patterned metal layer and a method of manufacturing the same, and a method of manufacturing a recording medium having a patterned recording layer using the imprint master.

The above Publication relates to a technique of forming a patterned recording layer on one surface of a magnetic disk medium and does not take into consideration a relationship in relative positions of patterns between both sides of the magnetic disk medium.

In order to secure an adequate recording capacity in such a magnetic disk drive, generally, it is essential to form a recording layer on either side of a single disk medium. In this disk medium, an uneven pattern is formed using spin on glass (SOG) or the like as materials for forming a mask on a disk substrate. It is thus necessary to form patterns on both sides of the disk medium at once by a single pressing step using a pair of stampers.

In a disk drive loaded with a disk medium, the positions of magnetic heads that contact both sides of the disk medium need to be controlled together. If uneven patterns are formed on their respective sides of the disk medium, it is desirable that these patterns coincide with each other precisely and completely.

However, there is no technique for making the patterns on both sides of a patterned disk medium on which an uneven pattern is physically formed coincident with each other precisely. This technique appears to be very difficult to achieve.

The present invention has been developed in consideration of the above situation and its object is to provide a perpendicular recording patterned disk medium whose patterns on its both sides coincide with each other precisely, and a magnetic disk drive loaded with the patterned disk medium.

### BRIEF SUMMARY OF THE INVENTION

According to an aspect of the present invention, there is provided a perpendicular recording patterned disk medium comprising a disk-shaped flat substrate having a first surface and a second surface opposed to the first surface, a data pattern area formed in advance on each of the first and second surfaces of the substrate, a servo pattern area formed in advance like an arc in a radial direction, which divides the data pattern area of each of the first and second surfaces into a plurality of pattern areas in a circumferential direction, and positioning marks formed on the first and second surfaces of the substrate, the positioning marks being used for positioning when the servo pattern area and the data pattern area are formed simultaneously in advance.

According to another aspect of the present invention, there is provided a magnetic disk drive comprising a perpendicular recording patterned disk medium including a disk-shaped flat substrate having a first surface and a second surface opposed to the first surface, a data pattern area formed in advance on each of the first and second surfaces of the substrate, a servo pattern area which is formed in advance like an arc in a radial direction, which divides the data pattern area of each of the first and second surfaces into a plurality of pattern areas in a circumferential direction, and positioning marks formed on the first and second surfaces of the substrate, the positioning marks being used for positioning when the servo pattern area and the data pattern area are formed simultaneously in advance, a first magnetic head provided on the first surface of the patterned disk medium, and a second magnetic head provided on the second surface of the patterned disk medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are plan views of patterns on both sides of a patterned disk medium according to an embodiment of the present invention;

FIG. 2 is a plan view of the shape and position of a positioning mark on the patterned disk medium according to the embodiment of the present invention;

FIG. 3 is a diagram of the principle of positioning stampers on the patterned disk medium according to the embodiment of the present invention;

FIG. 4 is an illustration of a specific arrangement of a positioning mark of the stampers on the patterned disk medium according to the embodiment of the present invention;

FIG. 5 is an illustration of the stampers fixed and adjusted when the stampers are actually positioned on the patterned disk medium according to the embodiment of the present invention;

FIG. 6 is an illustration of another shape of the positioning mark on the patterned disk medium according to the embodiment of the present invention;

FIG. 7 is an illustration of another shape of the positioning mark on the patterned disk medium according to the embodiment of the present invention;

FIG. 8 is an illustration of another shape of the positioning mark on the patterned disk medium according to the embodiment of the present invention;

FIG. 9 is an illustration of another shape of the positioning mark on the patterned disk medium according to the embodiment of the present invention;

FIG. 10 is an illustration of another shape of the positioning mark on the patterned disk medium according to the embodiment of the present invention;

FIGS. 11A to 11E are illustrations each showing another shape of the positioning mark on the patterned disk medium according to the embodiment of the present invention; and

FIG. 12 is a plan view showing an example of another position of the positioning mark on the patterned disk medium according to the embodiment of the present invention.

### DETAILED DESCRIPTION OF THE INVENTION

An embodiment of the present invention will be described with reference to the accompanying drawings.

[Outline of Patterns of Double-Sided Perpendicular Recording Patterned Disk Medium]

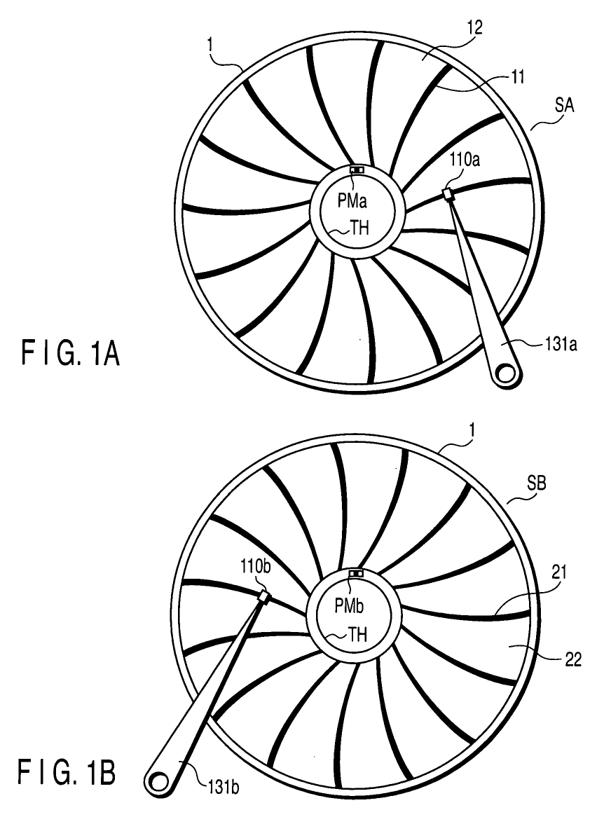

FIGS. 1A and 1B are plan views of the outline of patterns of a double-sided perpendicular recording patterned disk medium 1 according to the embodiment. FIG. 1A shows a pattern of the top surface SA of the disk medium 1 and FIG. 1B shows a pattern of the bottom surface SB thereof.

The patterned disk medium 1 is a small-diameter (e.g., 0.85 inch=approximately 21.6 millimeters) disk medium having a through hole TH (e.g., 6 mm in diameter) at the center thereof. The through hole TH is used to support the disk medium by a spindle motor (not shown). A margin is provided in each of the innermost and outermost radiuses of the top surface SA of the disk medium shown in FIG. 1A. A plurality of servo areas (servo pattern areas) 11 are each formed like an arc in the radial direction of the disk medium 1 and arranged in the circumferential direction thereof at regular intervals.

The arc corresponds to the track (head access track) of a magnetic head 110a that moves above the disk medium 1 when the disk medium 1 is loaded into the magnetic disk drive. The magnetic head 110a is provided at the tip of a head arm 131a of the magnetic disk drive.

The length of each of the servo areas 11 in the circumferential direction of the disk medium 1, namely, the width of each of the servo areas 11 is set greater toward the outer radius of the disk medium 1.

On the bottom surface SB of the patterned disk medium 1 shown in FIG. 1B, too, a plurality of servo areas 21 are formed in the same manner as the servo areas 11. The servo areas 11 on the top surface SA and the servo areas 21 on the bottom surface SB are arranged in a mirror-symmetric fashion. The patterned disk medium 1 therefore has two sides.

The servo areas 11 are arranged to divide the top surface SA equally in the circumferential direction of the disk medium 1. The top surface SA is thus divided into servo sectors (data areas) the number of which is equal to that of servo areas 11. In the example shown in FIG. 1A, the top surface SA is divided into fifteen servo sectors. In actuality, the top surface SA is divided into not less than one hundred servo sectors.

On the top surface SA of the disk medium 1, an area interposed between adjacent servo areas 11 is called a data area 12. The data areas 12 are used to record/reproduce user data.

Assume that the disk medium 1 is a DTR type patterned disk medium in the present embodiment. In the data areas 12 of the disk medium 1, a plurality of ring-shaped magnetic tracks (not shown) called discrete tracks (DT) are formed in advance at regular intervals (track pitches Tp) in the radial direction of the data areas 12.

The user data is recorded on the magnetic tracks as a magnetization pattern. The magnetic tracks are formed convexly on an underlying layer of a substrate (not shown) that constitutes the disk medium 1, using a ferromagnet (e.g., CoCtPt) serving as a recording layer (magnetic layer). An area between adjacent magnetic tracks is a concave nonrecordable nonmagnetic one that is called a nonmagnetic guard.

The magnetism of the ring-shaped magnetic tracks is divided in the radial direction of the disk medium 1. The data areas 12 are configured by the magnetic tracks that are formed at regular intervals with a nonmagnetic area therebetween. The DTR type disk medium 1 so configured can prevent each magnetic track from being subjected to an interference from its adjacent tracks and thus contributes to higher packaging density of the disk medium 1. As described above, the top surface SA of the disk medium 1 is divided into servo areas 11 and data areas 12 in equal numbers. This means that the magnetic tracks arranged on the top surface SA in the circumferential direction of the disk medium 1 are equal in number to the servo areas 11.

In addition, a single positioning mark PMa is formed in the inner radius outside a pattern area covering the servo areas 11 and data areas 12. The positioning mark PMa is formed by a stamper in a transfer step described later and its forming position corresponds to a given servo sector such as a reference servo sector with number “0.”

The bottom surface SB has the same arrangement as that of the top surface SA to achieve mirror symmetry. The bottom surface SB includes a positioning mark PMb as well as servo areas 21 and data areas 22. The positioning mark PMb is located in that position in the inner radius which corresponds to a given servo sector such as a reference servo sector with number “0.”

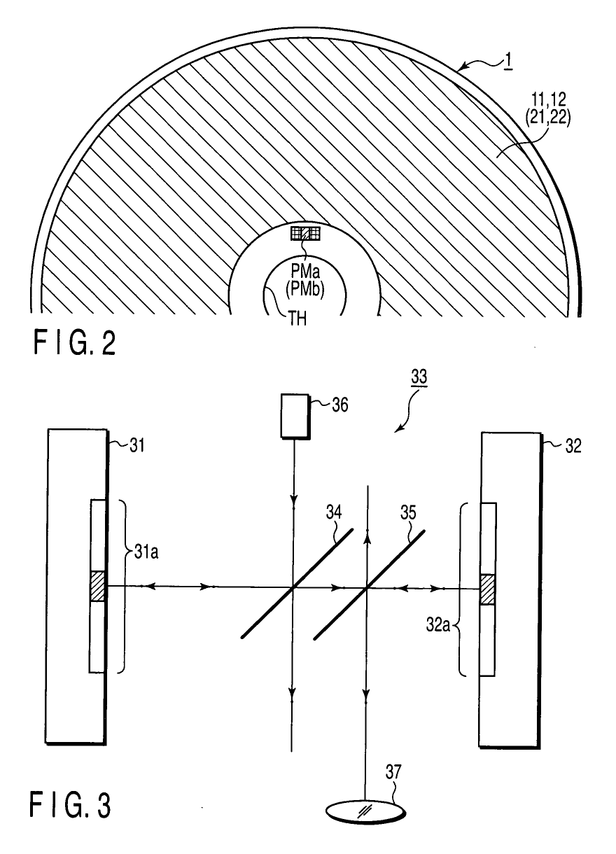

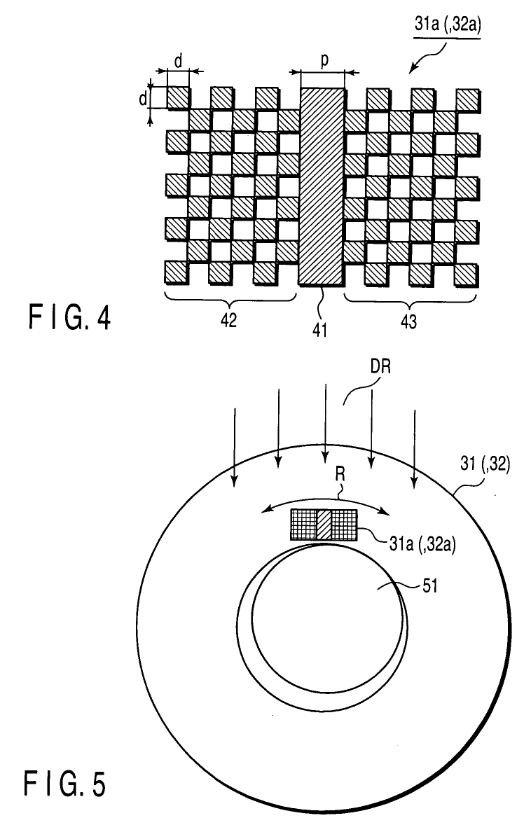

FIG. 2 shows a relationship in position between the positioning mark PMa, the servo areas 11 and the data areas 12 on the top surface SA of the patterned disk medium 1. In FIG. 2, the servo and data areas 11 and 12 are hatched together. The positioning mark PMa is located in the inner radius of the disk medium 1 outside a range covering the areas 11 and 12. It is also located in a position away from the through hole TH by a margin for supporting at least the spindle motor when the disk medium 1 is loaded into the disk drive. Specific shapes and structures of the positioning mark PMa will be described later with reference to FIG. 4.

Similarly, on the bottom surface SB of the disk medium 1, the positioning mark PMb of the same shape as that of the positioning mark PMa is located in the inner radius of the medium 1 outside a range covering the servo and data areas 21 and 22.

As described above, the positioning marks PMa and PMb are formed in a position corresponding to a given servo sector and exactly coincide with each other in the thickness direction of the disk medium 1, or the direction perpendicular to the sheet of FIG. 2.

[Outline of Method of Manufacturing a Disk Medium]

A method of manufacturing the disk medium 1 will be described in brief. This method includes a transfer step, a magnetization step and a finishing step. First, a method of manufacturing a stamper used in the transfer step will be described.

The method of manufacturing the stamper is divided into pattern drawing, developing, electrotyping and finishing steps.

In the pattern drawing step, an area that is not to be magnetized on the disk medium is drawn on the resist-coated original master by exposure from the inner radius to the outer radius, using an electron beam exposure device of an original master rotating type.

In the developing step, the resist of the original master is developed after the pattern drawing step, and the resist-developed master original is processed by RIE or the like to obtain the original master having an uneven pattern.

In the electrotyping step, the original master with the uneven pattern is processed to be conductive and its surface is electrotyped with nickel (Ni). A Ni plate having an uneven pattern is peeled off the original master and finally stamped into the inner and outer radiuses to obtain a Ni disk-shaped stamper.

The nonmagnetic portion of the stamper is formed as a convex. Using this stamper, the patterned disk medium 1 is manufactured.

In the transfer step, an imprinting device of a double-sided simultaneous transfer type is used to transfer a pattern as follows by imprint lithography.

First, both sides of a perpendicular magnetic recording disk substrate are coated with resist. This disk substrate is obtained by forming a magnetic layer having perpendicular magnetic anisotropy on the entire surface of each of underlying layers on both sides of a substrate (glass substrate).

The through hole TH is formed in the central part of the disk substrate such that the substrate can be supported by the spindle motor.

The disk substrate is chucked by the through hole TH. Then, the disk substrate is caught between two stampers prepared for both sides thereof and pressed equally thereon to transfer an uneven pattern onto the resist-coated sides.

In the transfer step, an area to be nonmagnetized is formed as a concave on the resist-coated sides.

FIG. 3 illustrates positioning of the above two stampers, which is performed before the transfer step. Referring to FIG. 3, two stampers 31 and 32 are arranged in parallel with each other and their positioning marks 31a and 32a are opposed to each other as precisely as possible.

In this state, a beam splitter 33 is interposed between the stampers 31 and 32. The beam splitter 33 includes a pair of half mirrors 34 and 35, a laser beam source 36 and a light-receiving unit 37.

The half mirrors 34 and 35 are arranged in parallel with each other and located between the positioning marks 31a and 32a of the stampers 31 and 32 such that they are inclined at an angle of 45 degrees to the opposing axis of the positioning marks.

Parallel laser beams strike into the half mirror 34 from the laser beam source 36, which is arranged above. Some of the laser beams are reflected by the half mirror 34 and applied perpendicularly to the positioning mark 31a of the stamper 31.

Some of the laser beams reflected by the positioning mark 31a pass through the half mirrors 34 and 35 and then are reflected by the positioning mark 32a of the stamper 32. Further, some of the laser beams reflected by the mark 32a are reflected by the half mirror 35 and then guided to the light-receiving unit 37.

If the positioning marks 31a and 32a are adjusted separately while monitoring the intensity (brightness) of light received by the light-receiving unit 37, the two stampers 31 and 32 can be positioned with precision.

FIG. 4 illustrates a specific arrangement of the positioning marks 31a and 32a of the stampers 31 and 32. As shown in FIG. 4, the positioning marks 31a and 32a each include a reflection area 41 and a pair of reflection areas 42 and 43 having a two-dimensional diffraction grating structure. The area 41 is formed between the areas 42 and 43.

In FIG. 4, the hatched portions are formed as a convex of each of the stampers 31 and 32. In FIG. 4, the horizontal direction corresponds to the circumferential direction of the patterned disk medium 1 and the vertical direction corresponds to the radial direction thereof.

The reflection area 41 reflects all the incident laser beams. Specifically, when the reflection area 41 receives laser beams perpendicularly to the surface thereof, it reflects almost all the laser beams through the same laser beam axis. The reflection areas 42 and 43 having a two-dimensional diffraction grating structure, namely, a checkered uneven area reflect and scatter diffracted laser beams and thus greatly decrease in the number of reflected laser beams output through the same laser beam axis as that of incident laser beams.

The width p of the reflection area 41 in the lateral direction (in the circumferential direction of the disk medium 1) is set considerably greater than the width d of each of square lattices of the reflection areas 42 and 43, and the spot diameter of a laser beam output from the laser beam source 36 is set almost equal to the above width p. A difference in reflectivity of laser beams due to a difference in position between the reflection areas 41, 42 and 43 can precisely be sensed.

The spot diameter of a laser beam output from the laser beam source 36 is, for example, the order of 0.5 mm under the present circumstances. It is considerably greater than the length of each of the servo areas 11 of the disk medium 1 in its circumferential direction (i.e., the width of each of the servo areas 11). Accordingly, the width p of the reflection area 41 is also considerably greater than the width of each of the servo areas 11.

Actually, the stampers 31 and 32 are adjusted as follows. Referring to FIG. 5, a hub 51 passes through the punched inner radius of each of the stampers 31 and 32. The diameter of the hub 51 is almost equal to (slightly smaller than) that of the inner radius. Then, the stampers 31 and 32 are pressed on the hub 51 from the radial direction in which the positioning marks 31a and 32 are formed, as indicated by arrows DR. While errors caused in the fixing positions of the stampers 31 and 32 in the radial direction are minimized, the stampers 31 and 32 are rotated one by one at a very small angle in the direction indicated by double-headed arrow R. Thus, the opposed positioning marks 31a and 32a are positioned.

After the stampers 31 and 32 are positioned with precision, the perpendicular magnetic recording disk substrate is chucked by the through hole TH of the substrate as described above. Then, the entire surfaces of the disk substrate are caught by the stampers 31 and 32 at equal pressure to transfer an uneven pattern onto the resist-coated surface of the substrate.

In the magnetization step, the concave resist is removed to expose the surface of a magnetic layer of a portion to be nonmagnetized. Under this condition, resist is formed as a convex on the other portion of the magnetic layer which is left as a magnetic substance. Using this resist as a guard layer, both sides of the disk substrate are ion-milled to remove the magnetic layer only from the concave. A magnetic substance having a desired pattern is obtained.

After that, the resist is sputtered to have an adequate thickness and eliminate the uneven portions from the surfaces. This structure is reverse-sputtered to the surface of the magnetic layer to fill the concave with the nonmagnetic substance. The flattened patterned disk medium 1 can thus be obtained.

In the finishing step, both sides of the disk substrate with the magnetic substance is polished, then a DLC protecting layer is formed thereon, and the protecting layer is coated with lubrication. The disk medium 1 is completed. In this stage, however, the magnetic substance of both sides of the disk medium 1 is not magnetized and thus has to be done in the magnetizing step (not shown).

[Loading of Patterned Disk Medium into Disk Drive]

When the patterned disk medium 1 so completed is loaded into a disk drive, the positioning marks PMa and PMb on the top and bottom surfaces SA and SB of the disk medium 1 shown in FIGS. 1A and 1B are each located almost in the innermost radius of the disk medium 1 and outside a margin for supporting the spindle motor.

The operating ranges of the magnetic heads 110a and 110b, which are provided at the tips of the head arms 131a and 131b of the drive whose oscillations are controlled integrally with each other, are restricted by an inner-radius stopper (not shown). Thus, the magnetic heads 110a and 110b cannot physically be arrived at the positions of the positioning marks PMa and PMb outside the access area that covers the servo areas 11 and 21 and data areas 12 and 22.

Since the magnetic heads 110a and 110b are formed integrally with the head arms 131a and 131b, respectively, the disk medium 1 is caught between the heads. The magnetic heads 110a and 110b are so controlled that they are always opposed to each other.

As described above, the patterned disk medium 1 is formed with the pattern in which the positioning marks PMa and PMb, servo areas 11 and 21, and data areas 12 and 22 coincide with each other in a mirror-symmetric fashion in the thickness direction of the medium 1.

Consequently, the magnetic heads 110a and 110b are always located opposed to each other in the same servo pattern position, and no time lag occurs when the heads are switched to each other. When the magnetic heads are frequently switched to read/write data, the disk drive can be improved in performance, specifically in write/read access speed and the control required for the access can be simplified, as a prior art magnetic disk drive for magnetically writing servo information to a medium.

[Another Example of Positioning Marks]

The positioning marks, which are used for positioning the stampers 31 and 32 and thus formed on the patterned disk medium 1, are not limited to only the shape shown in FIG. 4. Various modifications can be made to the positioning marks. Some of them will be described with reference to FIGS. 6 to 11.

FIG. 6 illustrates a positioning mark in which a rectangular reflection area 61 for reflecting all laser beams is caught between reflection areas 62 and 63 whose reflectivity is greatly lower than that of the reflection area 61. In FIG. 6, the horizontal direction corresponds to the circumferential direction of the patterned disk medium 1 and the vertical direction corresponds to the radial direction thereof.

FIG. 7 illustrates a positioning mark in which a square reflection area 71 for reflecting all laser beams is coaxially surrounded with a rectangular reflection area 72 whose reflectivity is greatly lower than that of the reflection area 71. In FIG. 7, the horizontal direction corresponds to the circumferential direction of the patterned disk medium 1 and the vertical direction corresponds to the radial direction thereof.

If the reflection areas 71 and 72 that differ in reflectivity are arranged in the radial direction of the patterned disk medium 1, the stampers 31 and 32 can finely be adjusted in the radial direction as well as in the circumferential direction of the disk medium 1 and thus positioned with precision.

FIG. 8 illustrates a positioning mark in which a circular reflection area 81 for reflecting all laser beams is concentrically surrounded with a circular reflection area 82 whose reflectivity is greatly lower than that of the reflection area 81.

In FIG. 8, the horizontal direction corresponds to the circumferential direction of the patterned disk medium 1 and the vertical direction corresponds to the radial direction thereof.

If the two coaxial reflection areas 81 and 82 that differ in reflectivity are arranged and the diameter of the reflection area 81 is almost equal to that of the spot diameter of a laser beam emitted from the laser beam source 36 of the beam splitter 33, the stampers 31 and 32 can finely be adjusted in the radial direction as well as in the circumferential direction of the disk medium 1 and thus positioned with high precision.

FIG. 9 illustrates a positioning mark in which a rectangular reflection area 91 for reflecting all laser beams is caught between rectangular reflection areas 92, 94 and 96 and rectangular reflection areas 93, 95 and 97 whose reflectivities each differ from that of the reflection area 91.

In FIG. 9, the horizontal direction corresponds to the circumferential direction of the patterned disk medium 1 and the vertical direction corresponds to the radial direction thereof. The reflectivity of the reflection area 91 is the highest, and the other reflection areas gradually decrease in reflectivity with distance from the area 91. In other words, four reflectivities are set. It is thus possible to easily determine the direction of rotation for precise positioning based on the intensity (brightness) of laser beams received by the light-receiving unit 37 of the beam splitter 33.

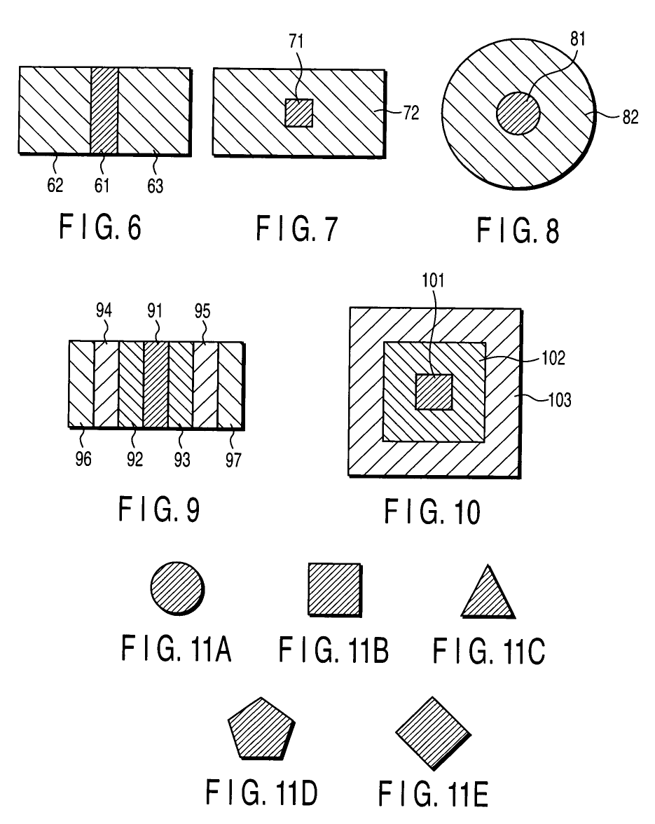

FIG. 10 illustrates a positioning mark in which a square reflection area 101 for reflecting all laser beams is concentrically surrounded with rectangular reflection areas 102 and 103 which differ in reflectivity from the reflection area 101.

In FIG. 10, the horizontal direction corresponds to the circumferential direction of the patterned disk medium 1 and the vertical direction corresponds to the radial direction thereof. The reflectivity of the reflection area 101 is the highest, and the other reflection areas gradually decrease in reflectivity with distance from the area 101. In other words, three reflectivities are set. It is thus possible to finely adjust the stampers 31 and 32 in the radial direction as well as in the circumferential direction of the disk medium 1 based on the intensity (brightness) of laser beams received by the light-receiving unit 37 of the beam splitter 33. The stampers are therefore easily positioned with precision.

FIGS. 4 and 6 to 10 each show reflection areas whose reflectivities differ from each other and whose shapes correspond to each other. The present invention is not limited to this. The shape of the middle reflection area for reflecting all laser beams need not always correspond to that of a reflection area that is formed adjacent to the middle reflection area and different in reflectivity.

FIGS. 11A, 11B, 11C, 11D and 11E illustrate reflection areas shaped like a circle, a square, a regular triangle, an equilateral pentagon, and a rhombus, respectively. Each of the reflection areas can be combined with its adjacent reflection area in an arbitrary shape into a positioning mark.

The reflection areas shown in FIGS. 11A to 11E can be used alone as well as in combination with another one with different reflectivity. The present invention is not limited to the reflection areas shown in FIGS. 11A to 11E. They can be shaped like an equilateral hexagon, a star (pentalpha, hexalpha), etc.

In FIGS. 1A, 1B, 2, etc., the positioning marks PMa and PMb are located in the inner radius of the disk medium 1 that falls outside a pattern area covering the servo and data areas 11 and 12. The present invention is not limited to this location.

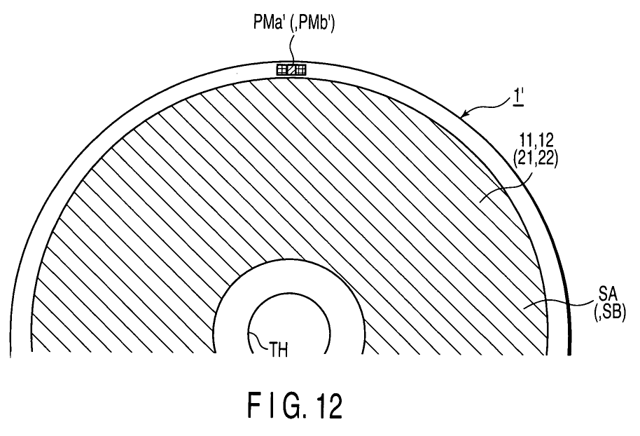

FIG. 12 shows a positioning mark PMa′ (PMb′) that is located in the outer radius of a disk medium 1 that falls outside a pattern area covering the servo areas 11 (21) and data areas 12 (22) on the top surface SA (bottom surface SB) of the disk medium 1′.

In a magnetic disk drive of a head load/unload type, an area for loading/unloading a magnetic head into/from a ramp member is secured in the outermost radius of the medium 1′. Since this area is not a range to be accessed directly by the magnetic head, it is very effective to form a pattern on each of the stampers 31 and 32 in order to locate the positioning mark PMa′ (PMb′) in the outermost radius of the medium 1. The problem that a range covering the servo and data areas 11 and 12 is narrowed can be avoided.

The foregoing embodiment is directed chiefly to a DTR type patterned disk medium and a magnetic disk drive using the disk medium. The present invention is not limited to this but can be applied to another type patterned disk medium in which various patterns are physically formed on the surface of a disk.

In a magnetic disk drive that is loaded with a plurality of patterned disk mediums coaxially with a single spindle motor, it seems important to make the patterns of the surfaces of all the disk mediums coincident with one another in order to easily control access to the disk mediums and improve the speed of access thereto. However, it is the minimum premise that the patterns of both sides of each of the disk mediums coincide with each other. In this respect, the present invention is effective.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A perpendicular recording patterned disk medium comprising:
a disk-shaped flat substrate having a first surface and a second surface opposed to the first surface;
a data pattern area formed in advance on each of the first and second surfaces of the substrate;
a servo pattern area formed in advance like an arc in a radial direction, which divides the data pattern area of each of the first and second surfaces into a plurality of pattern areas in a circumferential direction; and
positioning marks formed on the first and second surfaces of the substrate, the positioning marks being used for positioning when the servo pattern area and the data pattern area are formed simultaneously in advance.

2. The perpendicular recording patterned disk medium according to claim 1, wherein the positioning marks coincide with each other in a direction perpendicular to the first and second surfaces.

3. The perpendicular recording patterned disk medium according to claim 1, wherein the positioning marks are formed in advance outside a range covering the servo pattern area and the data pattern area.

4. The perpendicular recording patterned disk medium according to claim 3, wherein the positioning marks are formed in advance on an inner radius of each of the first and second surfaces outside a range covering the servo pattern area and the data pattern area.

5. The perpendicular recording patterned disk medium according to claim 1, wherein the positioning marks are formed in advance in positions corresponding to a same sector number of the first and second surfaces.

6. The perpendicular recording patterned disk medium according to claim 2, wherein the positioning marks are formed in advance in positions corresponding to a same sector number of the first and second surfaces.

7. The perpendicular recording patterned disk medium according to claim 1, wherein the positioning marks each have a circumferential-direction length which is greater than that of the servo pattern area.

8. A magnetic disk drive comprising:
a perpendicular recording patterned disk medium including a disk-shaped flat substrate having a first surface and a second surface opposed to the first surface, a data pattern area formed in advance on each of the first and second surfaces of the substrate, a servo pattern area which is formed in advance like an arc in a radial direction, which divides the data pattern area of each of the first and second surfaces into a plurality of pattern areas in a circumferential direction, and positioning marks formed on the first and second surfaces of the substrate, the positioning marks being used for positioning when the servo pattern area and the data pattern area are formed simultaneously in advance;
a first magnetic head provided on the first surface of the patterned disk medium; and
a second magnetic head provided on the second surface of the patterned disk medium.

9. The magnetic disk drive according to claim 8, wherein the positioning marks are each formed in advance outside a range of access for each of the first and second magnetic heads.
